(19) United States
(12) Patent Application Publication
(10) Pub. No.: US 2010/0194023 A1
(43) Pub. Date: Aug. 5, 2010

(54) SHEET FINISHING APPARATUS, SHEET FINISHING METHOD, IMAGE FORMING APPARATUS

(75) Inventors: Shogo OZAWA, Shizuoka (JP); Yoshiaki SUGIZAKI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/699,645

(22) Filed: Feb. 3, 2010

Related U.S. Application Data
(60) Provisional application No. 61/150,274, filed on Feb. 5, 2009.
(60) Provisional application No. 61/150,277, filed on Feb. 5, 2009.
(60) Provisional application No. 61/178,372, filed on May 14, 2009.

(51) Int. Cl. B42B 9/06; B65H 33/00

(52) U.S. Cl. 270/58.08; 270/58.12

(57) ABSTRACT

A sheet finishing apparatus includes a bonding unit including a supply section configured to sequentially supply each of binding tapes, at one ends of which an adhesive is applied, to a conveyed sheet and a bonding section configured to bond a surface of the supplied binding tape, on which the adhesive is applied, to an end face of the conveyed sheet.

### CROSS-REFERENCE TO RELATED APPLICATION

This application is based upon and claims the priority of U.S. Provisional Application No. 61/150,274, filed on Feb. 5, 2009, U.S. Provisional Application No. 61/150,277, filed on Feb. 5, 2009, and U.S. Provisional Application No. 61/178,372, filed on May 14, 2009, the entire contents of which are incorporated herein by reference.

### TECHNICAL FIELD

The present invention relates to a sheet finishing apparatus, a sheet finishing method, and an image forming apparatus for applying finishing to sheets discharged from an image forming apparatus such as a copying machine, a printer, or a multi-function peripheral (MFP).

### BACKGROUND

In recent years, in an image forming apparatus (e.g., MFP), a sheet finishing apparatus is provided adjacent to a post-stage of the MFP to apply finishing to sheets subjected to image formation. The sheet finishing apparatus is called finisher. The sheet finishing apparatus punches, staples, or sorts sheets sent from the MFP and discharges the sheets.

In binding sheets, in general, a method of stapling the sheets using a stapler or a method of punching holes in the sheets using a puncher and binding the sheets in a binder or the like is adopted. On the other hand, there is also known a technique for binding the sheets using paper to reduce the burden on the earth's environment.

JP-A-8-39959 and JP-A-10-871 disclose a binder that binds sheets using tapes and disclose an example in which sheets are stapled by using binding tapes. JP-A-10-872 discloses an example in which binding tapes are bonded on a peeling tape in a continuous state.

However, in all the related arts is difficult to reuse the sheets because the sheets are scratched, since the sheets are stapled.

### SUMMARY

An object of the present invention is to provide a sheet finishing apparatus that can bind sheets without scratching the sheets.

According to an aspect of the present invention, a sheet finishing apparatus including:

a conveying mechanism configured to convey a sheet;

a bonding unit including a supply section configured to sequentially supply each of binding tapes, at one ends of which an adhesive is applied, to the conveyed sheet and a bonding section configured to bond a surface of the supplied binding tape, on which the adhesive is applied, to an end face of the conveyed sheet; and

a discharge mechanism configured to discharge the sheet to which the binding tape is bonded by the bonding unit.

### DESCRIPTION OF THE DRAWINGS

FIG. 1 is a front view of an image forming apparatus and a sheet finishing apparatus according to an embodiment;

FIG. 2 is a diagram of a staple unit of a finisher;

FIG. 3 is a perspective view of a main part of the staple unit viewed from an arrow A direction in FIG. 2;

FIG. 4 is a perspective view of the configuration of the stapler;

FIG. 5 is a perspective view of the overall configuration of a punch unit;

FIG. 6 is a plan view of the specific configuration of the punch unit;

FIG. 7 is a plan view of a state in which binding tapes are bonded to a sheet;

FIGS. 8A and 8B are respectively a plan view and a sectional view of a state in which the binding tapes are punched;

FIGS. 9A and 9B are respectively a plan view and a sectional view of a state in which the binding tapes are stapled;

FIG. 10 is a front view of an example of a bonding unit;

FIG. 11 is a front view of a state in which the binding tape is bonded to the upper surface of the sheet;

FIG. 12 is a front view of another example of the bonding unit;

FIG. 13 is a front view of a state in which the a binding tape is bonded to the lower surface of the sheet;

FIG. 14 is a front view of still another example of the bonding unit;

FIG. 15 is a front view of a state in which the binding tapes are bonded to both the surfaces of the sheet;

FIGS. 16A to 16G are diagrams for explaining the operation of the bonding unit of FIG. 14;

FIG. 17 is a perspective view of a state in which the binding tapes are bonded to both the surfaces of the sheet;

FIGS. 18A to 18D are plan views for explaining binding applied to the binding tapes;

FIGS. 19A to 19D are plan views of an example in which the binding tapes are subjected to the biding with a bonding position(s) thereof changed;

FIGS. 20A to 20D are plan views of an example in which the position(s) of stapling is (are) changed according to the thickness of a sheet bundle;

FIGS. 21A to 21D are plan views of another example in which the position(s) for stapling is (are) changed according to the thickness of a sheet bundle; and

FIG. 22 is a block diagram of a control system for the image forming apparatus and the finisher.

### DETAILED DESCRIPTION

Throughout this description, the embodiments and examples shown should be considered as exemplars, rather than limitations on the apparatus of the present invention.

A sheet finishing apparatus according to an embodiment is explained below with reference to the accompanying drawings. In the respective figures, the same components are denoted by the same reference numerals and signs.

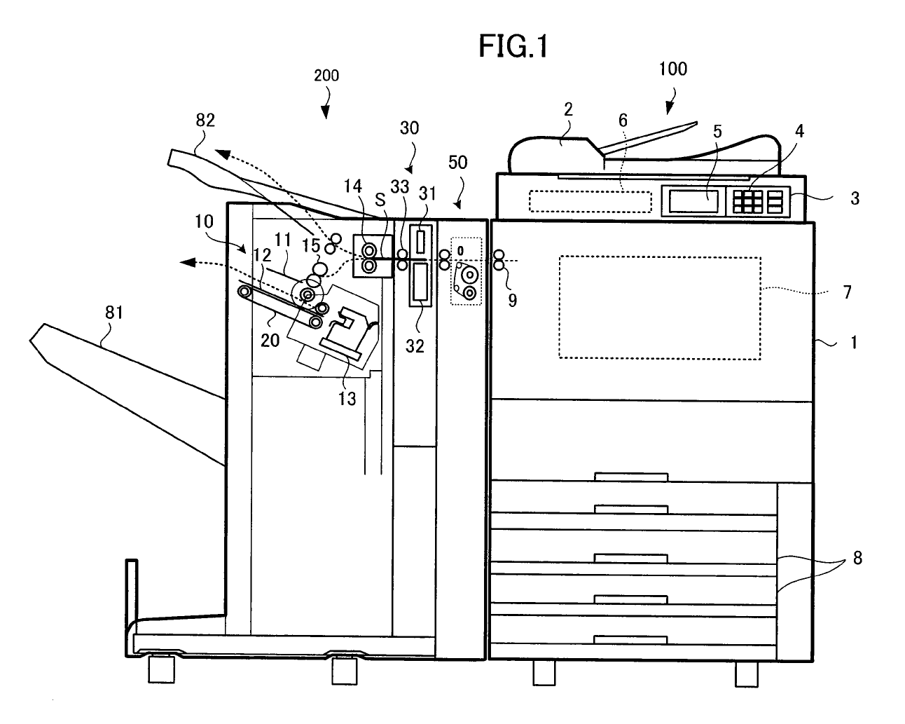

FIG. 1 is a front view of the configuration of an image forming apparatus including the sheet finishing apparatus. In FIG. 1, reference numeral 100 denotes the image forming apparatus such as a multi-function peripheral (MFP) as a complex machine, a printer, or a copying machine. A sheet finishing apparatus 200 is arranged adjacent to the image forming apparatus 100. The sheet finishing apparatus 200 is hereinafter referred to as finisher 200.

Sheets having images formed thereon by the image forming apparatus 100 are conveyed to the finisher 200. The finisher 200 applies finishing to the sheets fed from the image forming apparatus 100. For example, the finisher 200 bonds binding tapes to the sheets and punches, sorts, or staples the sheets.

A document table is provided in an upper part of a main body 1 of the image forming apparatus 100. An auto document feeder (ADF) 2 is provided on the document table to be freely opened and closed. An operation panel 3 is provided in an upper part of the main body 1. The operation panel 3 includes an operation section 4 including various keys and a display section 5 of a touch panel type.

The main body 1 includes a scanner section 6 and a printer section 7. Plural cassettes 8 having stored therein sheets of various sizes are provided in a lower part of the main body 1. The scanner section 6 reads a document fed by the ADF 2 or a document placed on the document table.

The printer section 7 includes a photoconductive drum and a laser. The surface of the photoconductive drum is scanned and exposed by a laser beam from the laser to form an electrostatic latent image on the photoconductive drum. A charging device, a developing device, a transfer device, and the like are arranged around the photoconductive drum. The electrostatic latent image on the photoconductive drum is developed by the developing device and a toner image is formed on the photoconductive drum. The toner image is transferred onto a sheet by the transfer device. The configuration of the printer 7 is not limited to the example explained above and can be various types.

Sheets having images formed thereon by the main body 1 are conveyed to the finisher 200. In the finisher 200, a staple unit 10 is arranged on a most downstream side of a conveying path for the sheets, a punch unit 30 is arranged upstream of the staple unit 10, and a tape bonding unit 50 is arranged upstream of the punch unit 30.

The tape bonding unit 50 bonds the binding tapes to the sheets discharged from the image forming apparatus 100. The punch unit 30 opens punch holes in the binding tapes bonded to the sheets. The staple unit 10 applies stapling to the binding tapes. The sheets finished by the finisher 200 are discharged to a storage tray 81 or a fixed tray 82. The storage tray 81 can be lifted and lowered.

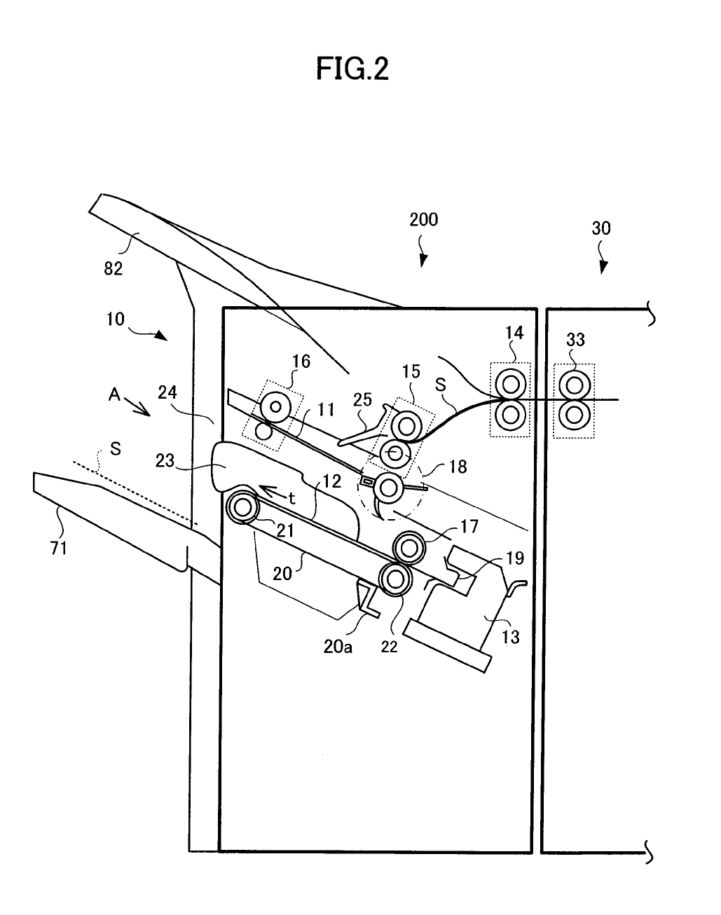

FIG. 2 is a diagram of the staple unit 10 of the finisher 200. A sheet S punched by the punch unit 30 is discharged from a discharge roller 33 and conveyed to the staple unit 10. The discharge roller 33 includes an upper roller and a lower roller.

The staple unit 10 includes a standby tray 11, a processing tray 12, and a stapler 13. The sheet S discharged by the discharge roller 33 of the punch unit 30 is received by an inlet roller 14 provided in a carry-in port of the staple unit 10. The inlet roller 14 includes an upper roller and a lower roller and is driven by a motor.

A paper feeding roller 15 is provided on the downstream side of the inlet roller 14. The sheet S received by the inlet roller 14 is fed to the standby tray 11 via the paper feeding roller 15. The paper feeding roller 15 includes an upper roller and a lower roller and is driven by a motor. The processing tray 12, on which the sheet S dropped from the standby tray 11 is stacked, is arranged below the standby tray 11.

The sheet S is stacked on the standby tray 11, which has an openable structure. When a predetermined number of sheets S are accumulated on the standby tray 11, the standby tray 11 opens and the sheets S drop to the processing tray 12 with own weight thereof or according to the operation of a drop support member for forcibly dropping the sheets S. The processing tray 12 supports the sheets S while the sheets S are stapled by the stapler 13.

The sheets S dropped to the processing tray 12 are guided to the stapler 13 by a roller 17 and stapled. The roller 17 is driven by a motor. The roller 17 rotates in opposite directions in guiding the sheets S in the direction of the stapler 13 and in discharging the stapled sheets S.

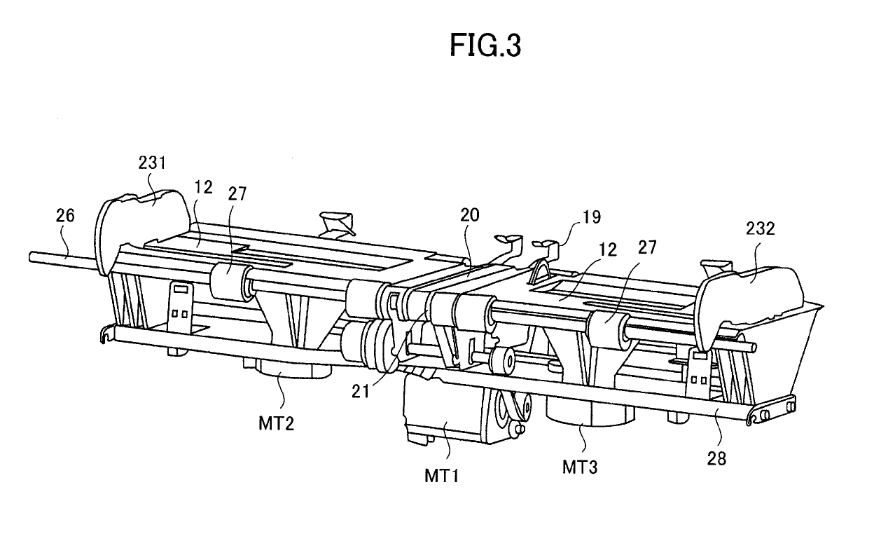

When stapled, the plural sheets S dropped from the standby tray 11 to the processing tray 12 are aligned in a longitudinal direction as a conveying direction and aligned in a lateral direction orthogonal to the conveying direction to be stapled. A lateral alignment plate 23 is provided to align the sheets S in the lateral direction. The lateral alignment plate 23 includes two lateral alignment plates 231 and 232 as explained later with reference to FIG. 3 and performs alignment and sorting of the sheets S.

To assist the sheets S in dropping to the processing tray 12, a rotatable puddle 18 is provided in a position where the trailing end of the sheets S drops. The paddle 18 is attached to a rotating shaft, flaps down the sheets S dropping from the standby tray 11 onto the processing tray 12, and sends the sheets S in the direction of the stapler 13.

A stopper 19 configured to regulate a trailing end position of the sheets S is provided at the end on the stapler 13 side of the processing tray 12. To convey the sorted or stapled sheets S to the storage tray 81, a conveyor belt 20 is provided. The conveyor belt 20 is suspended between pulleys 21 and 22. A pawl member 20a configured to catch the trailing end of the sheets S and send the sheets S is attached to the conveyor belt 20. A mechanism for rotating the pulleys 21 and 22 is omits.

When the conveyor belt 20 rotates in an arrow t direction, the sheets S are discharged from a discharge port 24 to the storage tray 81. The storage tray 81 is lifted and lowered by a motor to receive the sheets S. The conveyor belt 20 and the pawl member 20a guide the stapled sheets S to the discharge port 24.

When the sheets S stacked on the standby tray 11 are discharged to the storage tray 81 without being stapled, the sheets S are discharged by a rotating roller 16 without being dropped to the processing tray 12. The sheets S not required to be stapled can be discharged to the fixed tray 82. A conveying path for guiding the sheets S to the fixed tray 82 is provided. An assist arm 25 is swingably attached to an attaching shaft of the upper roller of the paper feeding roller 15. The assist arm 25 projects to a discharge side of the paper feeding roller 15. The assist arm 25 presses the trailing end side of the sheets S, which are discharged from the paper feeding roller 15, against the standby tray 11 to prevent the trailing end side from floating up.

FIG. 3 is a perspective view of a main part of the staple unit 10 viewed from an arrow A direction in FIG. 2. In FIG. 3, the configuration around the processing tray 12, the conveyor belt 20, and the lateral alignment plates 231 and 232 is shown. The pulley 21 is attached to a shaft 26. Discharge rollers 27 configured to discharge a sheet is attached to the shaft 26. A motor MT1 configured to drive the conveyor belt 20 and motors MT2 and MT3 configured to drive the lateral alignment plates 231 and 232 are attached to a frame 28. The lateral alignment plates 231 and 232 hold the sheets S from the lateral direction and align the sheets S.

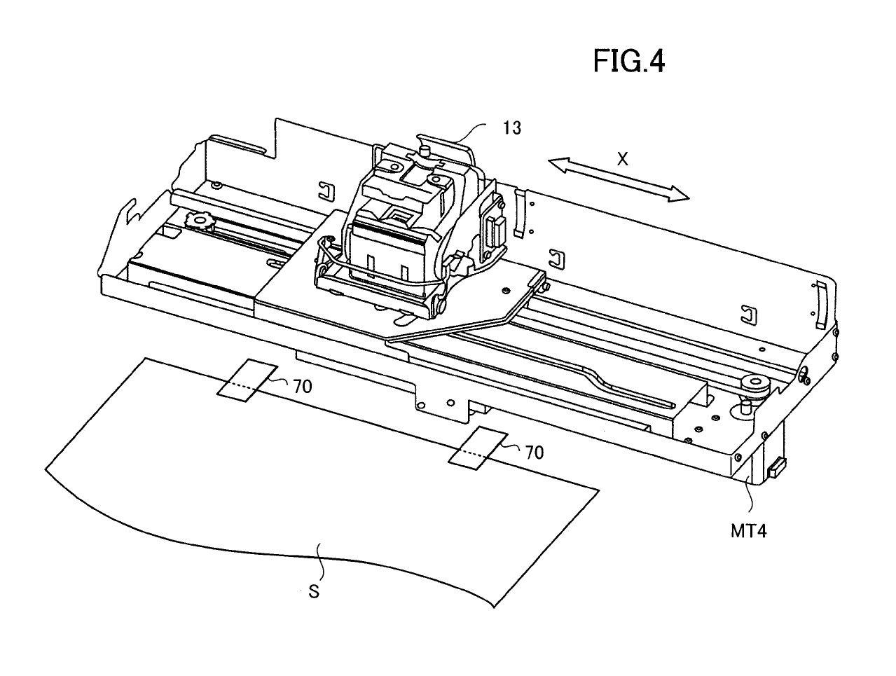

FIG. 4 is a perspective view of the configuration of the stapler 13. The stapler 13 can be slid in a direction (an X direction) orthogonal to the conveying direction of sheets by a motor MT4. The stapler 13 moves along the trailing end of the sheets S in stapling the sheets S and staples the sheets S or binding tapes 70 (explained later) bonded to the sheets S in a predetermined position(s) of a corner portion of the sheets S or the trailing end of the sheets S.

The motor MT4 is advisable to use a stepping motor that can control the number of revolutions according to the number of pulses or a frequency. A moving distance in the lateral direction (the X direction) of the stapler 13 can be managed according to the number of pulses in driving the motor MT4. A position(s) to be stapled can be accurately set.

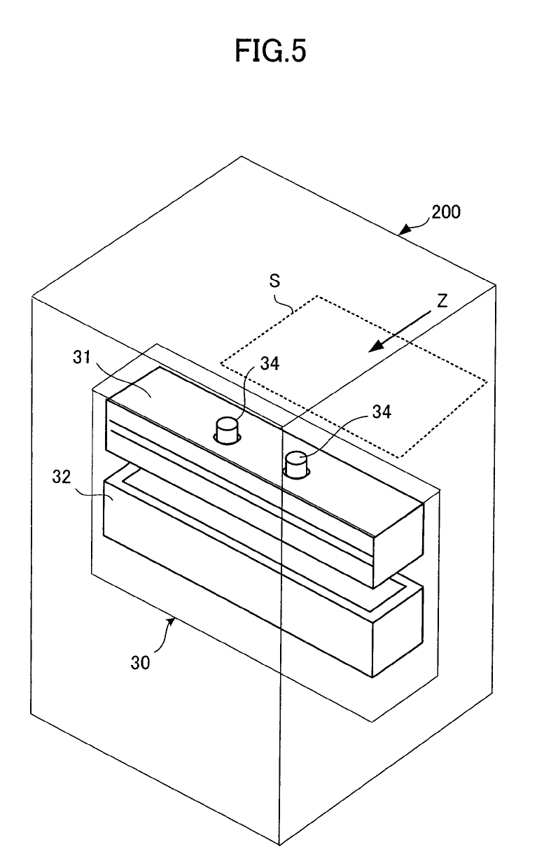

The punch unit 30 is explained below. As shown in FIGS. 1 and 5, the punch unit 30 is arranged upstream of the staple unit 10 and includes a puncher 31 and a dust box 32. The discharge roller 33 (FIG. 1) is provided at the final stage of the punch unit 30.

As shown in FIG. 5, the puncher 31 includes punching blades 34 configured to punch the sheet S. The punching blades 34 fall to punch the sheet S. Punch dust caused by the punching drops to the dust box 32. The punched sheet S is conveyed to the staple unit 10 by the discharge roller 33.

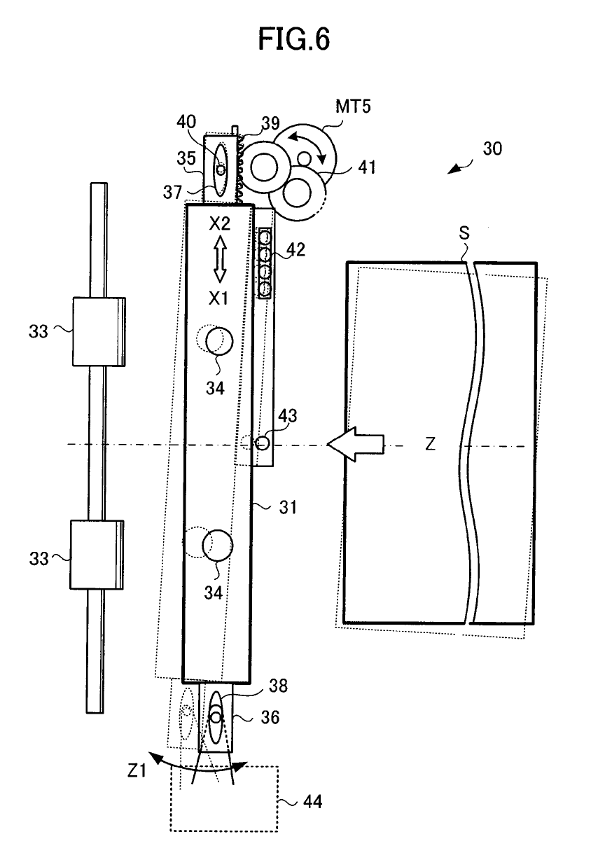

FIG. 6 is a plan view of the specific configuration of the punch unit 30. The punch unit 30 is arranged to be orthogonal to a conveying direction Z of the sheet S. The puncher 31 includes plural (two in FIGS. 5 and 6) punching blades 34. The punching blades 34 rise and fall according to the rotation of a punch motor. The punching blades 34 fall in a paper surface direction of the sheet S to open punch holes in the sheet S. An elevating mechanism for the punching blades 34 is omits because the elevating mechanism is generally well known.

The puncher 31 can move in arrow X1-X2 directions (the lateral direction) orthogonal to the conveying direction Z of the sheet S and change punching positions according to a sheet size or the like. Projected pieces 35 and 36 are respectively provided at both ends in the axis direction of the puncher 31. Long holes 37 and 38 are respectively formed in the projected pieces 35 and 36. A rack 39 is formed on a side of one projected piece 35. A fixed shaft 40 provided on the main body side of the finisher 200 is fit in the long hole 37 of the projected piece 35.

Therefore, the puncher 31 can move in the arrow X1-X2 directions within a range of the length of the long hole 37 using the fixed shaft 40 as a guide. A gear group 41 configured to mesh with the rack 39 and rotate is provided. The puncher 31 is moved in the lateral direction (the X1-X2 directions) according to the rotation of the gears. A motor MT5 rotates the gear group 41.

On a side of the puncher 31 where the sheet S is carried in, a sensor group 42 configured to detect an end in the lateral direction (a lateral end) of the sheet S and a sensor 43 configured to detect an end in the longitudinal direction (the leading end and the trailing end) of conveyance of the sheet S are provided.

In the sensor group 42 and the sensor 43, for example, light emitting elements and light receiving elements are arranged opposed to each other. When the sheet S is conveyed, the sheet S passes between the light emitting elements and the light receiving elements, whereby the sensor group 42 and the sensor 43 respectively detect the lateral end and the leading and trailing ends of the sheet S.

When the sheet S is conveyed to the punch unit 30, the sensor 43 detects the leading end of the sheet S and the motor MT5 drives the gear group 41 to once move the puncher 31 in the X2 direction orthogonal to the conveying direction Z of the sheet S and set the puncher 31 in a retracted position. When the sheet S is conveyed by a specified amount, the motor MT5 is reversely rotated to move the puncher 31 in the arrow X1 direction from the retracted position to the conveying path.

When the puncher 31 moves in the X1 direction, the sensor group 42 detects the lateral end of the sheet S, the motor MT5 stops to stop the puncher 31 in a punch position, and the punching blades 34 fall to open punch holes. In other words, the punching positions can be changed according to a size of the sheet S by moving the puncher 31 according to a detection result of the lateral end by the sensor 42.

The punch unit 30 includes a skew correcting section 44 configured to correct the skew of the sheet S. The skew correcting section 44 detects a tilt of the sheet S, pivots the projected piece 36 of the puncher 31 in a longitudinal direction Z1 according to an amount of the tilt. Therefore, even when the sheet S is conveyed on the skew, the puncher 31 opens punch holes in correct positions. For example, when the sheet S inclines as indicated by a dotted line, with the fixed shaft 40 as a fulcrum, the other end (the projected piece 36) of the puncher 31 pivots in the Z1 direction and inclines to perform skew correction.

The motor MT5 is advisable to use a stepping motor that can control the number of revolutions according to the number of pulses or a frequency. A moving distance in the lateral direction of the puncher 31 can be managed according to the number of pulses in driving the motor MT5. Punching positions can be accurately set.

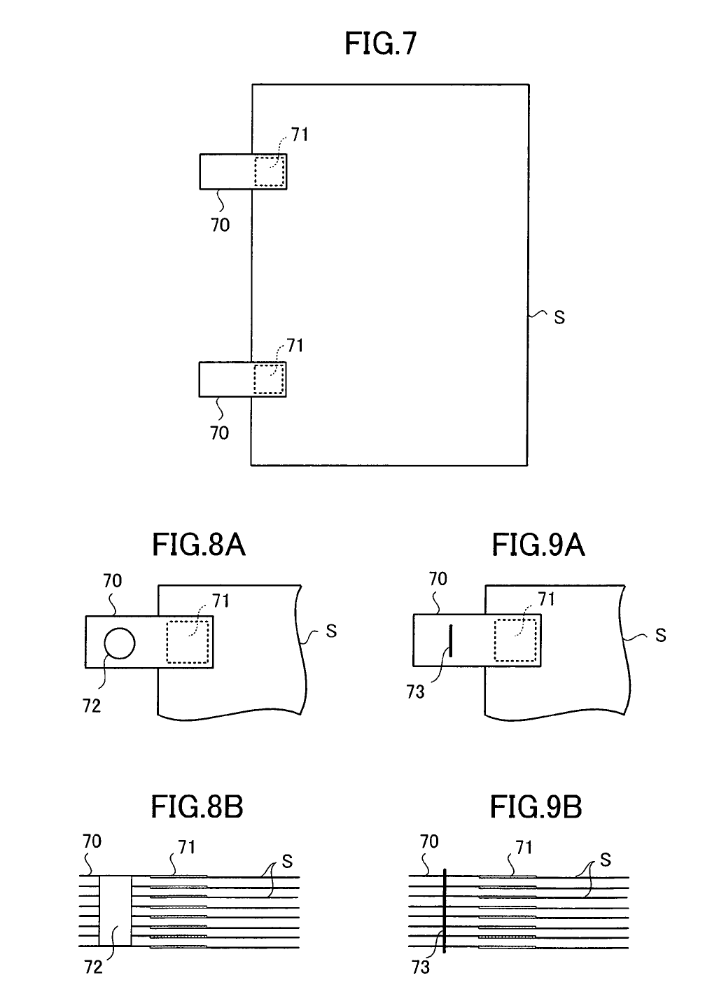

The bonding unit 50 for the binding tapes is explained below. FIG. 7 is a plan view of a shape of the binding tapes 70. As shown in FIG. 7, the binding tapes 70 have a rectangular shape. An adhesive 71 is applied to one side at one end of each of the binding tapes 70. The adhesive 71 has such bonding strength as to allow the binding tape 70 to be easily peeled off. The adhesive 71 is also called dummy adhesive. The end face of the binding tape 70 to which the adhesive 71 adheres is bonded to the sheet S, whereby a tab is formed.

In FIG. 7, a state in which a printing surface of the sheet S is faced up is shown. The binding tapes 70 are bonded to two places on the left side surface of the sheet S. Since the sheet S is conveyed with the printing surface faced down, actually, the binding tapes 70 are bonded to the trailing end in the conveying direction of the sheet S.

FIGS. 8A and 8B are diagrams of an example in which the binding tapes 70 are respectively bonded to the plural sheets S and a punch hole 72 is opened in the binding tapes 70. FIG. 8A is a plan view and FIG. 8B is a sectional view. The punch hole 72 is opened by the punch unit 30.

FIGS. 9A and 9B are diagrams of an example in which the binding tapes 70 are respectively bonded to the plural sheets S and stapling 73 is applied to the binding tapes 70. FIG. 9A is a plan view and FIG. 9B is a sectional view. The stapling 73 is performed by the staple unit 10.

In FIGS. 8A and 8B and FIGS. 9A and 9B, since the sheets S are not directly stapled, the sheets S are not scratched. Since the binding tapes 70 are bound by the punching or the stapling, the position of the punching or the stapling is a predetermined distance away from the sheets S. Therefore, when a sheet bundle is opened, folds are not formed on the sheets S.

The staple unit 10 and the punch unit 30 configure a binding section configured to apply binding to the binding tapes 70 bonded to the sheet bundle.

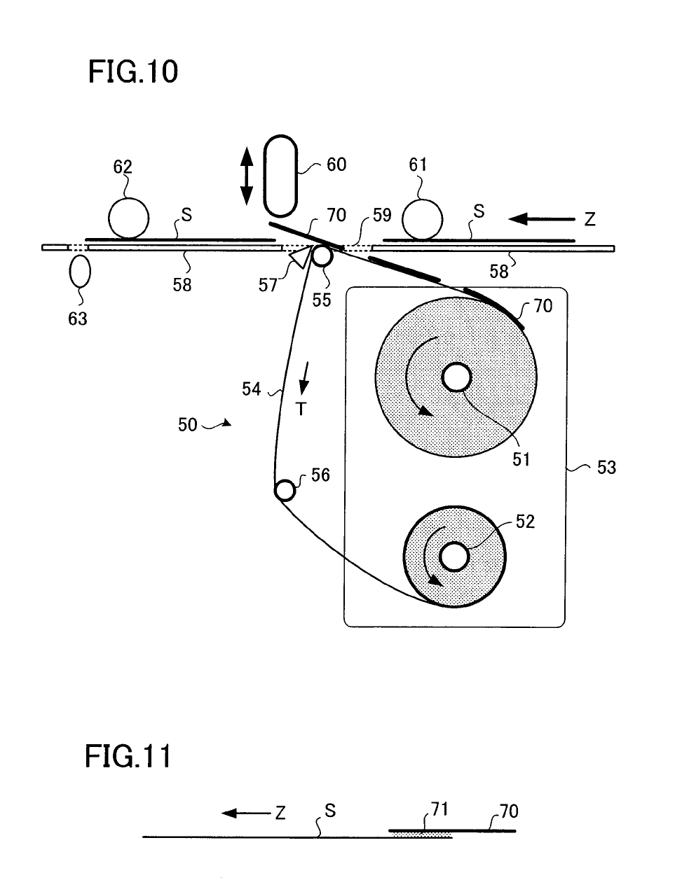

FIG. 10 is a front view of the bonding unit 50 configured to bond the binding tapes 70 to the sheet S.

The bonding unit 50 includes a cassette 53 including a supply reel 51 and a winding reel 52. A supply tape 54 is wound around the supply reel 51. The supply tape 54 is wound by the winding reel 52 via a relay roller 55 and a relay roller 56.

Plural binding tapes 70 are supported on the supply tape 54 while being continuously bonded to the supply tape 54. When a winding direction of the supply tape 54 is represented as T, the surface of the binding tape 70, to which the adhesive 71 is applied, is located on the leading end side in the winding direction T.

A peeling member 57 configured to peel off the binding tape 70 from the supply tape 54 is provided near the relay roller 55. While the supply tape 54 is being wound around the winding reel 52, when the binding tape 70 is about to be bent by the relay roller 55, the leading end of the binding tape 70 is peeled off by the peeling member 57.

On the other hand, the sheet S is fed to the bonding unit 50 from a conveying roller 9 provided in the main body 1 of the image forming apparatus 100. The sheet S is conveyed while being guided by a conveyance guide 58. A slit 59 is formed in the conveyance guide 58 for the sheet S. The binding tape 70 peeled off by the peeling member 57 is sent to the upper surface side at the trailing end of the sheet S via the slit 59.

The tape crimp 60 movable with respect to the paper surface of the sheet S is provided on the upper surface of the conveyance guide 58. The tape crimp 60 presses the surface of the adhesive 71 on the binding tape 70 against the upper surface of the trailing end of the sheet S. The tape crimp 60 is movable downward to the paper surface of the sheet S according to the rotation of an eccentric cam. The binding tape 70 and the sheet S are squeezed between the conveyance guide 58 and the tape crimp 60 to bond the binding tape 70 to the sheet S. Conveying rollers 61 and 62 configured to convey the sheet S and a sensor 63 configured to detect the sheet S are provided along the conveyance guide 58.

The rotation of the conveying rollers 61 and 62 and the rotation of the supply reel 51 and the winding reel 52 are controlled by using a detection result of the sensor 63. When the trailing end of the sheet S passes the slit 59, the conveyance of the sheet S is once stopped. The supply reel 51 and the winding reel 52 rotate to transfer the binding tape 70 to the upper surface of the trailing end of the sheet S via the slit 59. The tape crimp 60 is pressed in the paper surface direction to bond the binding tape 70 to the trailing end of the sheet S.

The bonding unit 50 can move in the direction (the X direction) orthogonal to the conveying direction Z of the sheet S and can bond the binding tapes 70 in plural places as shown in FIG. 7. The sheet S, to which the binding tape 70 is bonded, is conveyed again by the conveying roller 62 and fed to the punch unit 30. When the next sheet S is fed to the bonding unit 50, the bonding unit 50 repeats the operation for bonding the binding tape 70 to the sheet S and conveying the sheet S.

When the supply tape 54 wound around the supply reel 51 is entirely wound by the winding reel 52, the cassette 53 is replaced with a new one.

The conveying guide 58 and the conveying roller 61 configure a conveying mechanism configured to convey the sheet S. The supply reel 51, the winding reel 52, the supply tape 54, the relay roller 55, and the relay roller configure a supplying section configured to sequentially supply the binding tapes 70 to the conveyed sheet S.

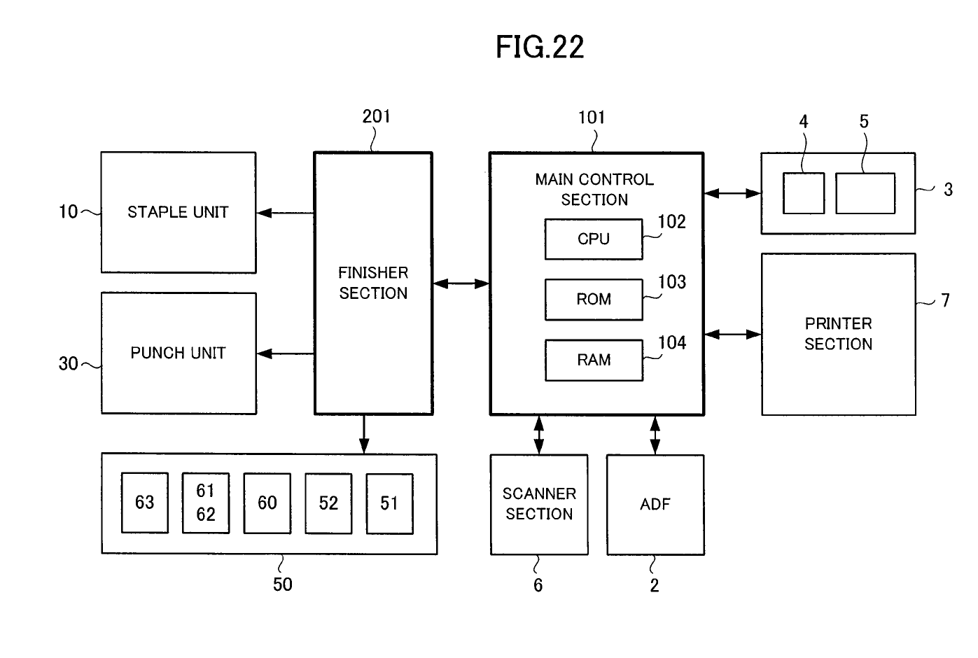

The tape crimp 60 and a control section 201 (explained later with reference to FIG. 22) configured to control the tape crimp 60 configure a bonding section configured to bond the binding tape 70 to the end face of the sheet S. The conveyance guide 58 and the conveying roller 62 configure a discharge mechanism configured to discharge the sheet S.

FIG. 11 is a front view of a state in which the binding tape 70 is bonded to the upper surface of the sheet S. The sheet S, to which the binding tape 70 is bonded, is conveyed to the punch unit 30 present downstream of the bonding unit 50.

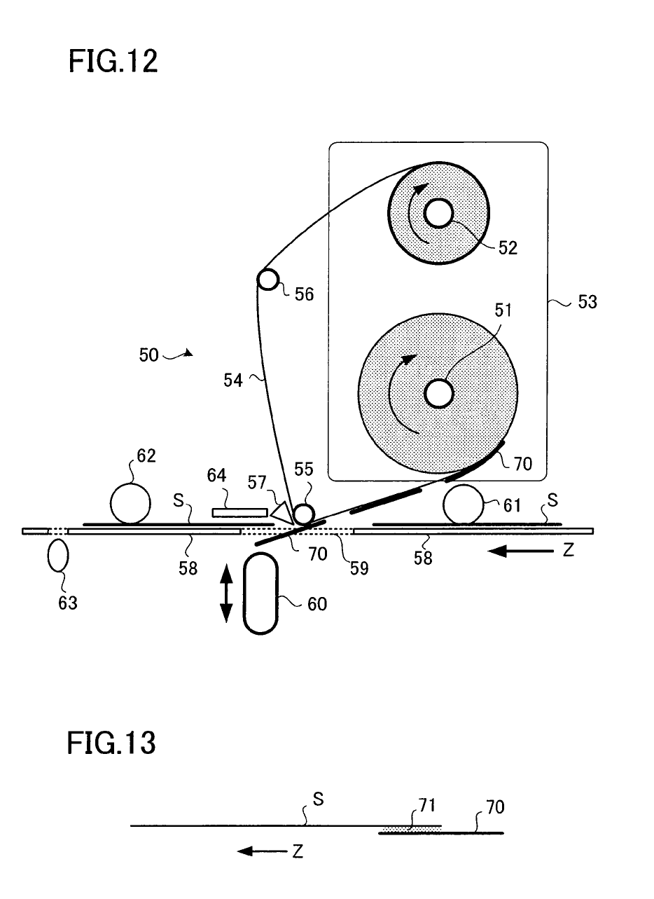

FIG. 12 is a front view of another example of the bonding unit 50. In FIG. 12, the binding tape 70 is bonded to the lower surface at the trailing end of the sheet S. Compared with FIG. 10, the upper side and the lower side of the conveyance guide 58 are reversed. The tape crimp 60 is movable upward to the paper surface of the sheet S.

A cover plate 64 is provided in a position opposed to the tape crimp 60. When the tape crimp 60 is moved upward, the binding tape 70 and the sheet S are squeeze between the cover plate 64 and the tape crimp 60 to bond the binding tape 70 to the sheet S.

FIG. 13 is a front view of a state in which the binding tape 70 is bonded to the lower surface of the sheet S.

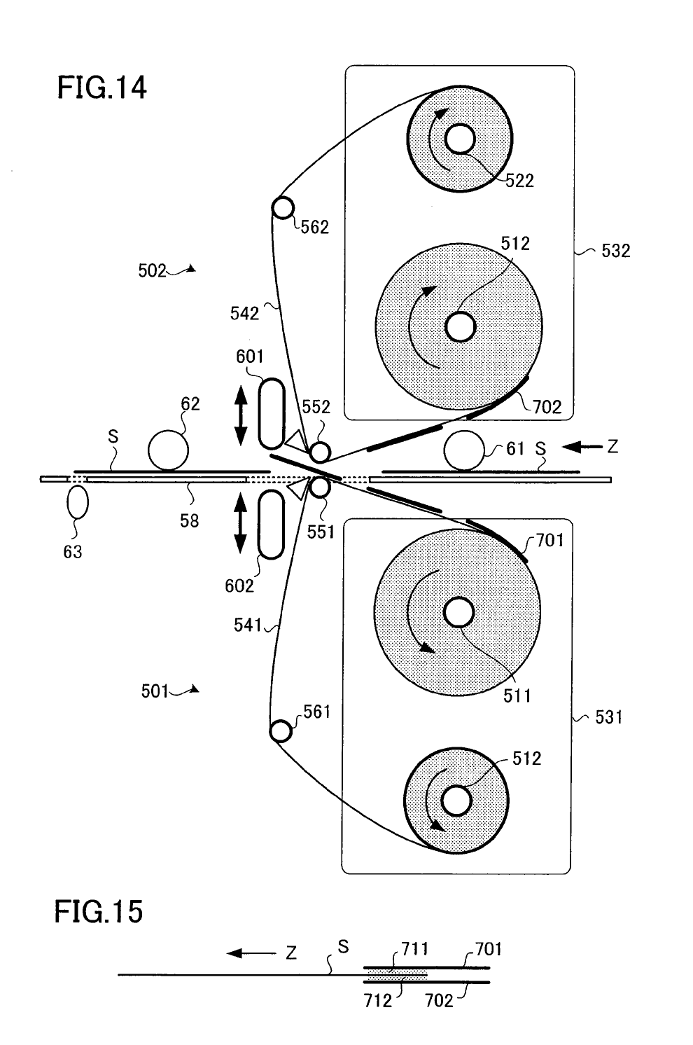

FIG. 14 is a front view of still another example of the bonding unit 50. In FIG. 14, the binding tapes 70 are bonded to the upper surface and the lower surface at the trailing end of the sheet S. A pair of the bonding units 50 are arranged on both the upper and lower sides of the conveyance guide 58. For convenience of explanation, the lower bonding unit 50 is referred to as bonding unit 501 and the upper bonding unit 50 is referred to as bonding unit 502. Similarly, “1” is suffixed to reference numerals of components of the bonding unit 501. “2” is suffixed to reference numerals of components of the bonding unit 502. Detailed description therefore is omitted.

Tape crimps 601 and 602 are present in positions opposed to each other. When the tape crimps 601 and 602 are moved in directions in which the tape crimps 601 and 602 come into contact with each other, the binding tapes 70 and the sheet S can be squeezed between the tape crimps 601 and 602 to bond the binding tapes 70 to the sheet S.

FIG. 15 is a front view of a state in which binding tapes 701 and 702 are bonded to the upper surface and the lower surface of the sheet S.

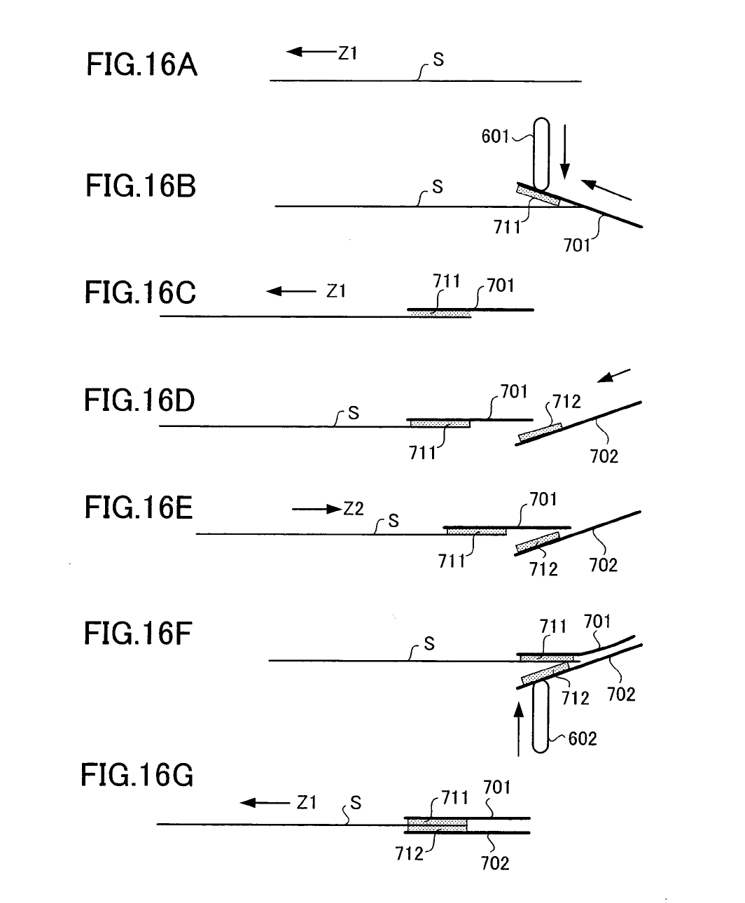

FIGS. 16A to 16G are diagrams for explaining operation in bonding the binding tapes 701 and 702 to the sheet S using the binding units 501 and 502 shown in FIG. 14.

In FIG. 16A, when the sheet S is conveyed in the Z1 direction, in FIG. 16B, the binding tape 701 is transferred from the bonding unit 501 to the upper surface side of the sheet S. The binding tape 701 is pressed against the trailing end of the sheet S by the tape crimp 601. In FIG. 16C, the sheets is conveyed a little in the Z1 direction and stopped. In FIG. 16D, the binding tape 702 is transferred from the bonding unit 502 to the lower surface side of the sheet S. In FIG. 16E, the sheet S is once conveyed in the opposite direction (a Z2 direction). In FIG. 16F, the binding tape 702 is pressed against the trailing end of the sheet S by the tape crimp 602. In FIG. 16G, the binding tapes 701 and 702 are bonded to both the surfaces at the trailing end of the sheet S. The sheets is conveyed in the Z1 direction. The bonding units 501 and 502 wait for the next sheet.

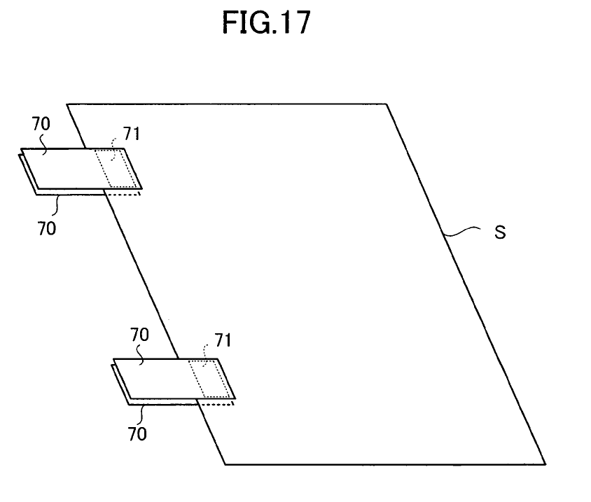

FIG. 17 is a perspective view of a state in which the binding tapes 70 are bonded to both the surfaces of the sheet S. In FIG. 17, a state in which the printing surface of the sheet S is faced up is shown. The binding tapes 70 are bonded to two places on the left side surface of the sheet S. Since the sheet S is conveyed with the printing surface faced down, actually, the binding tapes are bonded to the trailing end in the conveying direction of the sheet S.

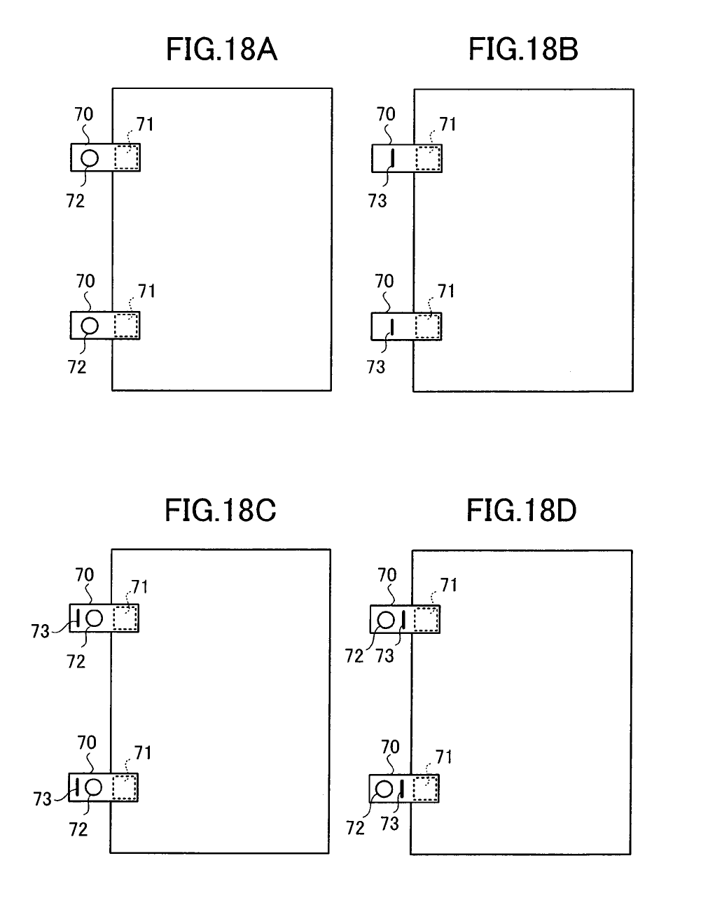

FIGS. 18A to 18D are plan views for explaining binding applied to the binding tapes 70 bonded to the sheets S. FIG. 18A is a plan view of an example in which the punch holes 72 are opened in the binding tapes 70. FIG. 18B is a plan view of an example in which the stapling 73 is applied to the binding tapes 70.

FIGS. 18C and 18D are diagrams of an example in which the punch holes 72 are opened in and the stapling 73 is applied to the binding tapes 70. In FIGS. 18C and 18D, the positions of the punch holes 72 and the stapling 73 are interchanged.

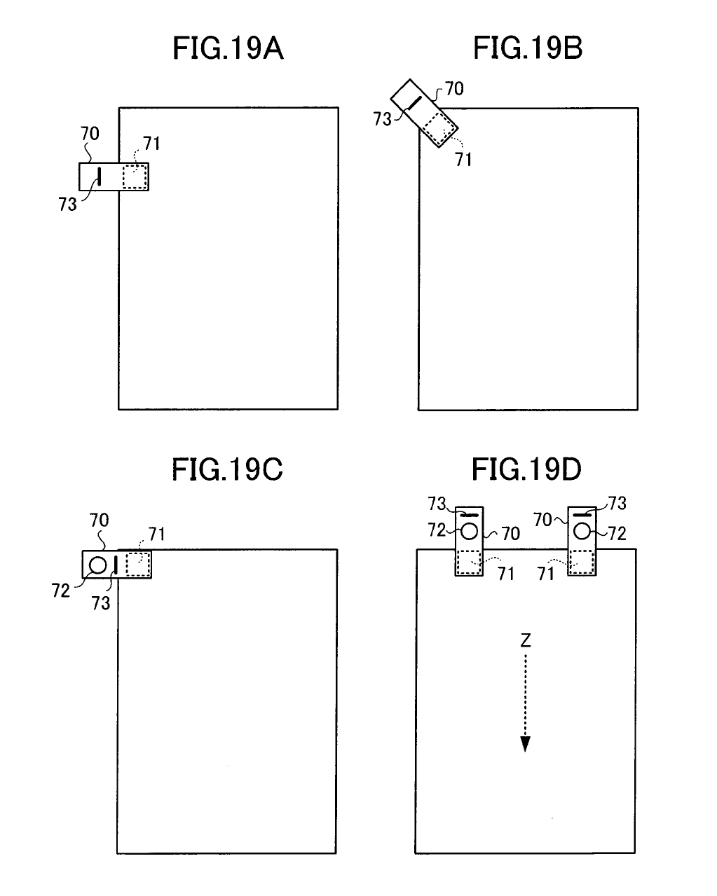

FIGS. 19A to 19D are plan views of an example in which a bonding position(s) of the binding tapes 70 is (are) changed and the binding is applied to the binding tapes 70. FIG. 19A is a plan view of an example in which the binding tapes 70 are bonded to one place on a side of the sheets S and the stapling 73 is applied to the binding tapes 70. FIG. 19B is a plan view of an example in which the binding tapes 70 are obliquely bonded to one place at a corner of the sheets S and the stapling 73 is applied to the binding tapes 70. In FIG. 19B is necessary to arrange the bonding unit 50 at an angle of 45 degrees with respect to the conveying direction of the sheet S.

FIG. 19C is a diagram of an example in which the binding tapes 70 are bonded near the corner at the left end of the sheets S and the stapling 73 is applied to and the punch hole 72 is opened in the binding tapes 70. FIG. 19D is a diagram of an example in which the binding tapes 70 are bonded to two places at the upper end of the sheets S and the stapling 73 is applied to and the punch holes 72 are opened in the binding tapes 70. In FIG. 19D, the binding tapes 70 are bonded to the sheets S while the sheets S are conveyed in a longitudinal direction (indicated by a dotted line).

In all the examples shown in FIGS. 18A to 18D and FIGS. 19A to 19D, since the punching and the stapling are not directly applied to the sheets S, the sheets S are not scratched. When the binding is unnecessary, the binding tapes 70 only have to be peeled off from the sheets S.

When the binding tapes 70 are bound, if the positions of the punching and the stapling are set away from the sheets S, folds are not formed on the sheets S when a sheet bundle is opened.

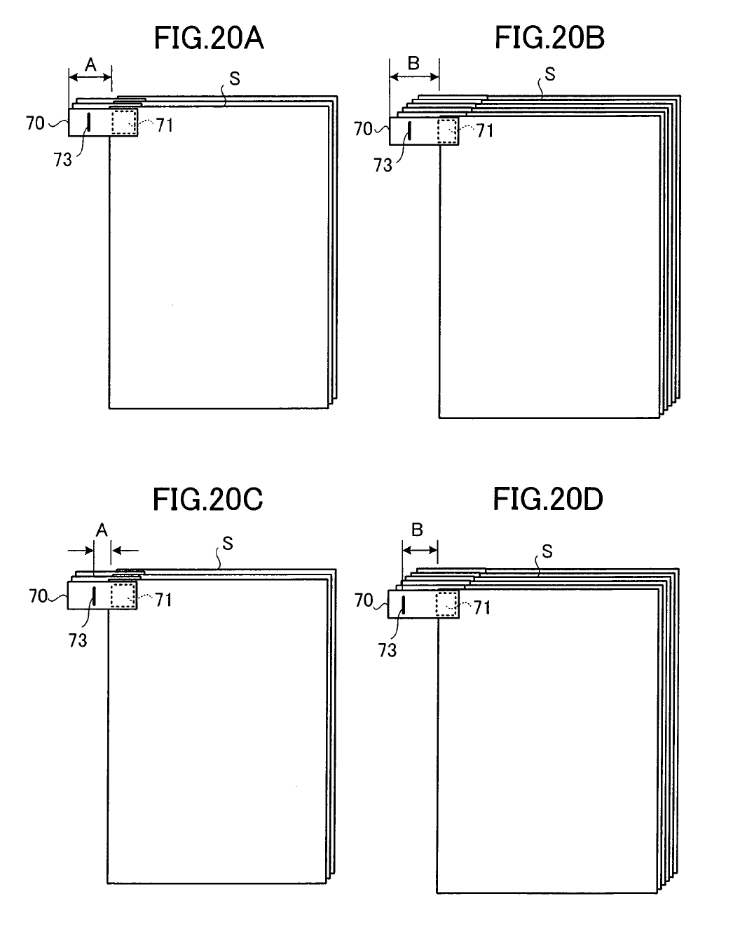

FIGS. 20A to 20D are plan views of an example in which the position (s) of stapling is (are) changed according to the thickness of a sheet bundle. The binding tapes 70 are bonded to the upper end on the left side surface of the sheets S. The stapling 73 can be easily applied to a sheet bundle including a small number of sheets S as shown in FIG. 20A even if a projection amount (length) of tabs formed by the binding tapes 70 is small. However, when the number of sheets S increases as shown in FIG. 20B, since difficult to staple the sheets S, advisable to increase the length of the tabs of the binding tapes 70. When the lengths of the tabs of the binding tapes 70 shown in FIGS. 20A and 20B are respectively represented as A and B, A is set smaller than B, accordingly easy to staple a large number of sheets to be bound and open the sheet bundle.

Alternatively, as shown in FIGS. 20C and 20D, the position of the stapling 73 may be changed according to the number of sheets S while the length of the tabs of the binding tapes 70 is kept the same. As shown in FIG. 20C, if the number of sheets S is small, the stapling 73 is applied in a position of the binding tapes 70 close to a sheet end. As shown in FIG. 20D, if the number of sheets S is large, the stapling 73 is applied to a position of the binding tapes 70 away from the sheet end. When the distances from the sheet end to the stapling 73 shown in FIGS. 20C and 20D are respectively represented as A and B, A is set smaller than B.

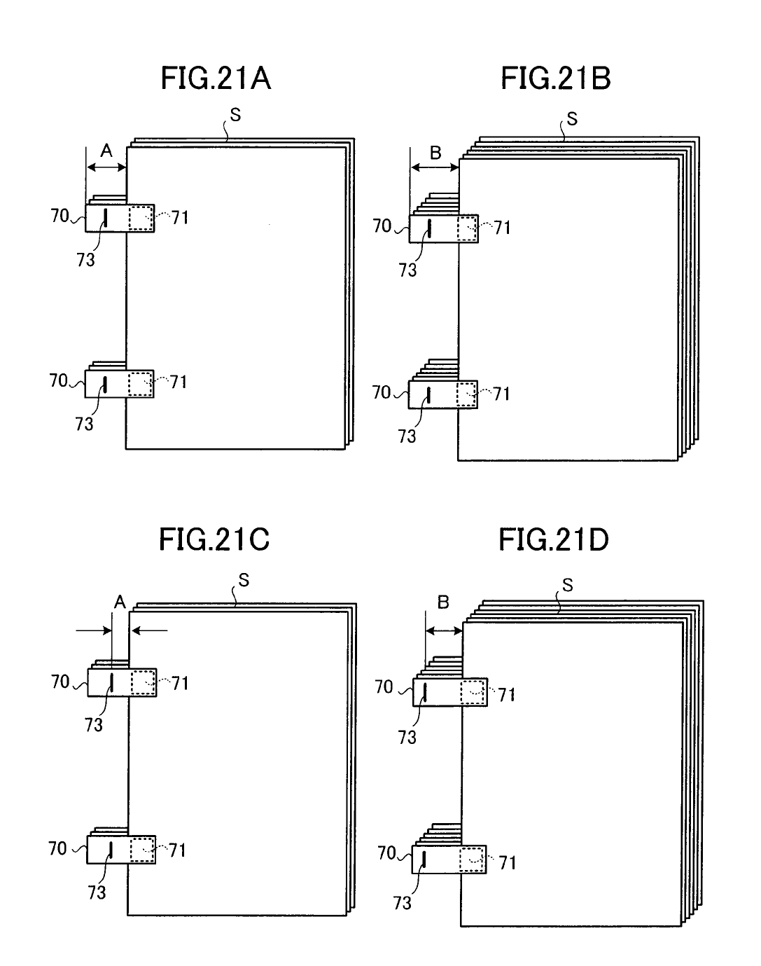

FIGS. 21A to 21D are plan views of another example in which the position (s) of the stapling is (are) changed according to the thickness of a sheet bundle. The binding tapes 70 are bonded to two places on the left side surface of the sheets S. In a sheet bundle including a small number of sheets S as shown in FIG. 21A, the projection amount (length) A of the tabs formed by the binding tapes 70 is set small. In a sheet bundle including a large number of sheets S as shown in FIG. 21B, the length B (A<B) of the tabs of the binding tapes 70 is set large to make it easy to open the sheet bundle.

Alternatively, as shown in FIGS. 21C and 21D, when the lengths of the tabs of the binding tapes 70 are set the same, if the number of sheets S is small, the stapling 73 is applied at the distance A of the binding tape 70 close to the sheet end and, if the number of sheets S is large, the stapling 73 is applied at the distance B of the binding tape 70 away from the sheet end.

In FIGS. 20A to 20D and FIGS. 21A to 21D, the examples of the stapling 73 applied to the binding tapes 70 are shown. However, even in an example of opening of a punch hole (s) in the binding tapes 70, advisable to change the position (s) of the punch hole (s) according to the number of sheets S.

FIG. 22 is a block diagram of a control system for the image forming apparatus 100 and the finisher 200.

In FIG. 22, a main control section 101 includes a CPU 102, a ROM 103, and a RAM 104. The CPU 102 controls the image forming apparatus 100 according to a control program stored in the ROM 103. The main control section 101 controls the operation of the ADF 2, the scanner section 6, and the printer section 7 in response to the operation of an operation panel 3. The RAM 104 temporarily stores control data and is used for arithmetic operation work during the control.

The operation panel 3 includes the plural keys 4 and the display section 5 also serving as a touch panel. A user can give various instructions for image formation to the image forming apparatus 100 through the operation panel 3. For example, the user gives instructions for the number of copies using the keys 4 and give instructions for a sheet size, a sheet type, stapling punching, bonding of a binding tape, and the like by operating the touch panel of the display section 5.

The finisher control section 201 controls the operation of the finisher 200. The finisher control section 201 is connected to the main control section 101 and transmits information to and receives information from the main control section 101. The image forming apparatus 100 and the finisher 200 operate in association with each other. The finisher control section 201 controls the staple unit 10, the punch unit 30, and the bonding unit 50.

Examples of the control of the staple unit 10 include a control of the position of the stapler 13, implementation of stapling, conveyance of the sheets S to the stapler 13, and discharge of a sheet bundle after the stapling. Examples of the control of the punch unit 30 include lifting and lowering of the punching blades 34, conveyance of the sheets S to the puncher 31, and carry-out of the sheets S after punching.

Examples of the control of the bonding unit 50 include detection of the sheet S by the sensor 63, conveyance and discharge of the sheet S by the conveying rollers 61 and 62, stop of the conveyance of the sheet S and rotation of the supply reel 51 and the winding reel 52, and movement of the crimping member 60 in the paper surface direction and bonding of the binding tape(s) 70 to the sheet S. The finisher control section 201 controls the position(s) of the binding tape(s) 70 bonded to the sheet S according to the position(s) of a punch hole(s) or the position(s) of stapling.

As explained above, in this embodiment, since the finisher 200 includes the bonding unit 50, possible to bind a sheet bundle without scratching sheets.

The present invention is not limited to the embodiment. Various modifications are possible without departing from the scope of claims.

Although exemplary embodiments are shown and described, it will be apparent to those having ordinary skill in the art that a number of changes, modifications, or alterations as described herein may be made, none of which depart from the spirit. All such changes, modifications, and alterations should therefore be seen as within the scope.

What is claimed is:

1. A sheet finishing apparatus comprising:
a conveying mechanism configured to convey a sheet;
a bonding unit including a supply section configured to sequentially supply each of binding tapes, at one ends of which an adhesive is applied, to the conveyed sheet and a bonding section configured to bond a surface of the supplied binding tape, on which the adhesive is applied, to an end face of the conveyed sheet; and
a discharge mechanism configured to discharge the sheet to which the binding tape is bonded by the bonding unit.

2. The apparatus of claim 1, wherein the bonding unit bonds the binding tape(s) to one or plural places of the end face of the conveyed sheet.

3. The apparatus of claim 1, wherein the bonding unit bonds the binding tape to at least one of an upper surface and a lower surface of the end face of the conveyed sheet.

4. The apparatus of claim 1, wherein the supply section of the bonding unit continuously supports the binding tapes on a supply tape wound between a supply reel and a winding reel and, while the supply tape is wound by the winding reel, sequentially peels off each of the binding tapes and supplies the binding tape to the end face of the sheet.

5. The apparatus of claim 1, wherein the bonding section of the bonding unit includes a crimping member configured to press the binding tape, which is supplied to the end face of the sheet, against the sheet.

6. The apparatus of claim 1, further comprising a binding section arranged on a downstream side of the bonding unit, wherein
the apparatus bundles up plural sheets and applies binding to the binding tapes bonded to the respective sheets.

7. The apparatus of claim 6, wherein the bonding section of the bonding unit changes a projection amount of tabs formed by the binding tapes according to a number of sheets subjected to the binding such that the projection amount of the tabs increases as the number of sheets increases.

8. The apparatus of claim 6, wherein the binding section switches a position of the binding according to a number of sheets and sets the position of the binding further away from end faces of the sheets as the number of sheets increases.

9. The apparatus of claim 6, wherein the binding section includes a stapler and a puncher and applies stapling to or opens punch holes in the binding tapes bonded by the bonding unit.

10. A sheet finishing method for a sheet finishing apparatus including a bonding unit configured to bond each of binding tapes, at one ends of which an adhesive is applied, to a sheet conveyed thereto, the method comprising:
conveying the sheet to the bonding unit;
sequentially supplying, with the bonding unit, each of the binding tapes to the conveyed sheet;
bonding a surface of the supplied binding tape, on which the adhesive is applied, to an end face of the conveyed sheet; and
discharging the sheet to which the binding tape is bonded.

11. The method of claim 10, wherein the bonding unit bonds the binding tape(s) to one or plural places of the end face of the conveyed sheet.

12. The method of claim 10, wherein the bonding unit bonds the binding tape to at least one of an upper surface and a lower surface of the end face of the conveyed sheet.

13. The method of claim 10, wherein a supply section of the bonding unit continuously supports the binding tapes on a supply tape wound between a supply reel and a winding reel and, while the supply tape is wound by the winding reel, sequentially peels off each of the binding tapes and supplies the binding tape to the end face of the sheet.

14. The method of claim 10, wherein the bonding unit presses the binding tape, which is supplied to the end face of the sheet, against the sheet using a crimping member.

15. The method of claim 10, wherein
the sheet finishing apparatus further includes a binding section arranged on a downstream side of the bonding unit, and
the method further comprises bundling up plural sheets and applying binding to the binding tapes bonded to the respective sheets.

16. The method of claim 15, further comprising changing a projection amount of tabs formed by the binding tapes according to a number of sheets subjected to the binding such that the projection amount of the tabs increases as the number of sheets increases.

17. The method of claim 15, wherein the binding section switching a position of the binding according to a number of sheets and sets the position of the binding further away from end faces of the sheets as the number of sheets increases.

18. The method of claim 15, wherein the binding section includes a stapler and a puncher and applies stapling to or opens punch holes in the binding tapes bonded by the bonding unit.

19. An image forming apparatus comprising:
an image forming section;
a conveying mechanism configured to convey a sheet fed from the image forming section;
a bonding unit including a supply section configured to sequentially supply each of binding tapes, at one ends of which an adhesive is applied, to the conveyed sheet and a bonding section configured to bond a surface of the supplied binding tape, on which the adhesive is applied, to an end face of the conveyed sheet; and
a binding section arranged on a downstream side of the bonding unit and configured to apply binding to the binding tape bonded by the bonding unit.

20. The apparatus of claim 19, wherein the binding section bundles up plural sheets and applies binding to the binding tapes bonded to the respective sheets and sets a position of the binding further away from an end face of the sheet as a number of sheets increases.
